(19) United States
(12) Patent Application Publication
(10) Pub. No.: US 2008/0181609 A1
(43) Pub. Date: Jul. 31, 2008

(54) METHODS AND APPARATUS FOR DESIGNING A FIBER-OPTIC NETWORK

(76) Inventors: Xiaochuan Yi, San Ramon, CA (US); Canhui Ou, Danville, CA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/627,724

(22) Filed: Jan. 26, 2007

(51) Int. Cl. H04J 14/00; H04B 10/20; H04L 12/28

(52) U.S. Cl. 398/58; 370/254

(57) ABSTRACT

Methods and apparatus for designing a fiber-optic network are disclosed. An example apparatus comprises a memory to store a first list of available fibers between a plurality of nodes of a fiber-optic network and a second list of forecasted services for the plurality of nodes, and a network planner to recursively trace a network design tree to identify a preferable network design based on the first and the second lists.

### FIELD OF THE DISCLOSURE

This disclosure relates generally to fiber-optic networks and, more particularly, to methods and apparatus for designing a fiber-optic network.

### BACKGROUND

In recent years, network providers have been integrating services to provide combined voice, data, and video services (sometimes referred to as triple-play services). The result has been a variety of new service offerings such as high-speed Internet, voice over Internet protocol (VoIP), and/or Internet protocol television (IPTV) in addition to the traditional services of telephone and/or data communications. Such triple-play services may be implemented and/or provided via a fiber-optic network.

### BRIEF DESCRIPTION OF THE DRAWINGS

FIGS. 1 and 2 are schematic illustrations of example fiber-optic communication systems.

FIG. 3 illustrates an example recursion of a network design tree.

FIG. 4 illustrates an example manner of implementing the example network planner of FIG. 1.

FIG. 5 illustrates an example manner of implementing the example user interface of FIG. 4.

FIG. 6 illustrates an example data structure that may be used to implement the example fiber configuration data of FIG. 4.

FIG. 7 illustrates an example data structure that may be used to implement the example traffic forecast data of FIG. 4.

FIG. 8 illustrates an example data structure that may be used to implement the example configuration data of FIG. 4.

FIGS. 9, 10 and 11 illustrate example class objects that may be used to implement the example network planner of FIGS. 1 and/or 4.

FIG. 12 is a flowchart representative of an example process that may be carried out to design a fiber-optic network.

FIGS. 13, 14 and 15 are flowcharts representative of an example process that may be carried out to implement the example network planner of FIGS. 1 and/or 4.

FIG. 16 is a flowchart representative of an example process that may be carried out to implement the example IO pair locator of FIG. 4.

FIG. 17 is a flowchart representative of an example process that may be carried out to implement the example IO placer of FIG. 4.

FIG. 18 is a flowchart representative of an example process that may be carried out to implement the example design selector of FIG. 4.

FIG. 19 is a flowchart representative of an example process that may be carried out to implement the example design comparer of FIG. 4.

FIGS. 20, 21A-21B, 22A-22B, 23A-B, 24A-24E illustrate example pseudo-code that may be used to implement the example network planner of FIGS. 1 and/or 4.

FIG. 25 is a schematic illustration of an example processor platform that may be used and/or programmed to carry out the example processes of FIGS. 12-19 and/or the example pseudo-code of FIGS. 20, 21A-21B, 22A-22B, 23A-B and/or 24A-24E to implement the example network planners described herein.

### DETAILED DESCRIPTION

Methods and apparatus for designing a fiber-optic network are disclosed. A disclosed example apparatus includes a memory to store a first list of available fibers between a plurality of nodes of a fiber-optic network and a second list of forecasted services for the plurality of nodes, and a network planner to recursively trace a network design tree to identify a preferable network design based on the first and the second lists.

A disclosed example method of designing a communication network includes adding a first intermediate office (IO) node pair to a first network design to form a second network design, adding a second IO node pair to the second network design to form a third network design when the second network design represents a potentially better solution than a previously preferred solution, and adding a third IO node pair to the first network design to form a fourth network design when the second network design represents a worse solution than the previously preferred solution.

A disclosed example article of manufacture includes machine readable instructions which, when executed, cause a machine to present a first interface that allows a user to provide a topology for a fiber-optic network, present a second interface that allows the user to provide traffic forecast data, and present a third interface that allows the user to initiate a recursive tracing of network design tree to select a design for the fiber-optic network.

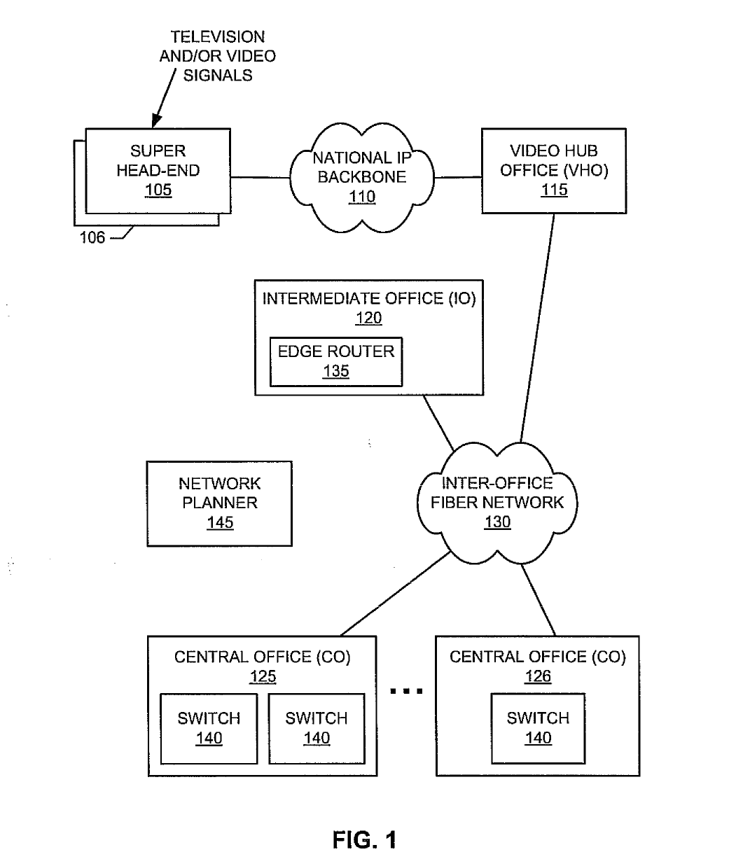

FIG. 1 illustrates an example fiber-optic communication system and/or network for providing triple-play services (e.g., high-speed Internet, voice over Internet protocol (VoIP) and/or Internet protocol television (IPTV)). While for ease of discussion the example fiber-optic communication system of FIG. 1 is described with reference to IPTV services, the example fiber-optic communication system may be used to provide any number and/or type(s) of additional and/or alternative services (e.g., VoIP and/or high-speed Internet services). Moreover, the methods and/or apparatus for designing a fiber-optic network described herein may be applied to other types of communication networks, such as public switched telephone network (PSTN) systems, public land mobile network (PLMN) systems (e.g., cellular), wireless distribution systems, wired or cable distribution systems, coaxial cable distribution systems, Ultra High Frequency (UHF)/Very High Frequency (VHF) radio frequency systems, satellite or other extra-terrestrial systems, cellular distribution systems, power-line broadcast systems, fiber optic networks, and/or any combinations and/or hybrids of these devices, systems and/or networks.

To acquire and/or encode video content, the example fiber-optic communication system of FIG. 1 includes one or more super head-ends, one of which is illustrated in FIG. 1 with reference numeral 105. The example super head-end 105 of FIG. 1 aggregates and/or encodes any number of television and/or video signals (e.g., hundreds and/or thousands) from around the globe. The super head-end 105 may, for example, be implemented at a location that facilitates the acquisition and/or aggregation of national-level broadcast TV (i.e., linear) programming. The example super head-end 105 may also implement an acquisition and/or insertion point for on-demand content. In some examples, a redundant super head-end 106 may be provided as backup to the super head-end 105 in case of failure. On-demand and/or linear programming may be received at the super head-end 105 via any number and/or type(s) of satellite and/or terrestrial signals that are processed and/or encoded according to codec and/or bit-rate requirements, and then transmitted via, for example, any type of national and/or global Internet Protocol (IP) backbone network 110 to video head-end offices (VHOs) (one of which is illustrated in FIG. 1 with reference numeral 115) that may be located across a wide geographic territory, such as an entire country.

The example VHO 115 of FIG. 1 is responsible for the distribution of IPTV content (e.g., linear and/or on-demand programming) within, for example, a particular demographic marketing area (DMA) and/or geographic region. However, a VHO 115 may distribute content for any portion and/or number of DMAs and/or geographic regions. The example VHO 115 may include any number of acquisition servers, video encoders/decoders and/or content servers (not shown). The VHO 115 distributes the IPTV content via any number of intermediate offices (one of which is illustrated in FIG. 1 with reference number 120) and any number of central offices (two of which are respectively illustrated in FIG. 1 with reference numbers 125 and 126). The example VHO 115, the example IO 120 and the example COs 125 and 126 of FIG. 1 are communicatively coupled via any number and/or type(s) of inter-office fiber-optic networks, one of which is illustrated in FIG. 1 with reference numeral 130.

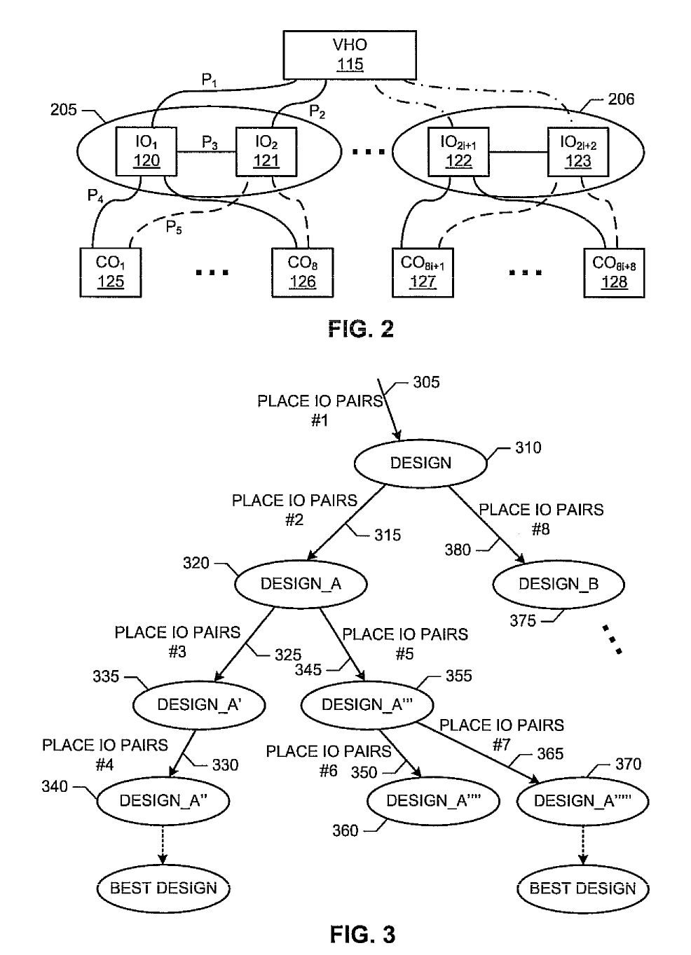

As described in more detail below in connection with FIG. 2, the example VHO 115, the example IO 120 and the example COs 125 and 126 are logically arranged in a hierarchy wherein the VHO 115 provides IPTV signals to one or more IOs 120. Each of the IOs 120 in turn provides the IPTV signals to one or more so-called “sub-tending” COs 125, 126 for delivery to subscribers (not shown). However, as illustrated in FIG. 1, the VHO 115, the IO 120 and the COs 125 and 126 are inter-connected via the fiber-optic network 130 and need not be physically coupled in the same hierarchy used to distribute IPTV content. For example, the IO 120 and the COs 125, 126 can be connected using any combination(s) of ring, star, and/or mesh topologies.

In the illustrated example of FIG. 1, each IO 120 includes and/or implements an edge router 135 (e.g., an Alcatel 7750 multi-service edge router), while each CO 125, 126 includes and/or implements one or more switches 140 (e.g., an Alcatel 7450 service switch). Moreover, intermediate offices (e.g., the example IO 120) are, in fact, central offices but, with regards to IPTV services, are distinguished from central offices (e.g., the COs 125 and 126) in that the IO 120 includes an edge router 135. An intermediate office may also implement one or more switches 140.

As described in more detail below in connection with FIG. 2, edge routers 135 and/or, more generally, IOs 120 are utilized and/or implemented in pairs (i.e., IO pairs). By using IO pairs and physical diversity of fiber-optic cables (e.g., two fiber optic cables are located and/or routed via two physical disparate trenches, pipes, ducts, tunnels, etc.), the example fiber-optic system of FIGS. 1 and 2 can be designed and, thus, implemented to survive equipment and/or transmission facility failures. Presently consider the example of FIG. 2, if a first edge router (e.g., located in IO 120) fails, its paired edge router (located in the other IO 121 of an IO pair 205) can continue to provide triple-play services for the sub-tending central offices (e.g., the COs 125 and 126) of the IO pair. If a fiber-optic cable (e.g., a cable P4) between the IO 120 of the IO pair 205 and a sub-tending CO 125 is cut, a physically diverse fiber-optic cable (e.g., a cable P5) between the other IO 121 of the IO pair 205 and the sub-tending CO 125 can be used to route triple-play service signals to the CO 125.

The example switches 140 of FIG. 1 provide IPTV services and/or signals to one or more subscribers, who may be located in single and/or multiple dwelling units (not shown). The switches 140 and/or, more generally, the example COs 125 and 126 provide the IPTV services to the subscribers via any number and/or type(s) of communication equipment and/or networks. For example, the subscribers may be coupled to the COs 125 and 126 via a fiber-to-the-pedestal (FTTP) network, a fiber-optic node, a fiber-to-the-node (FTTN) network and/or a fiber-optic to copper node.

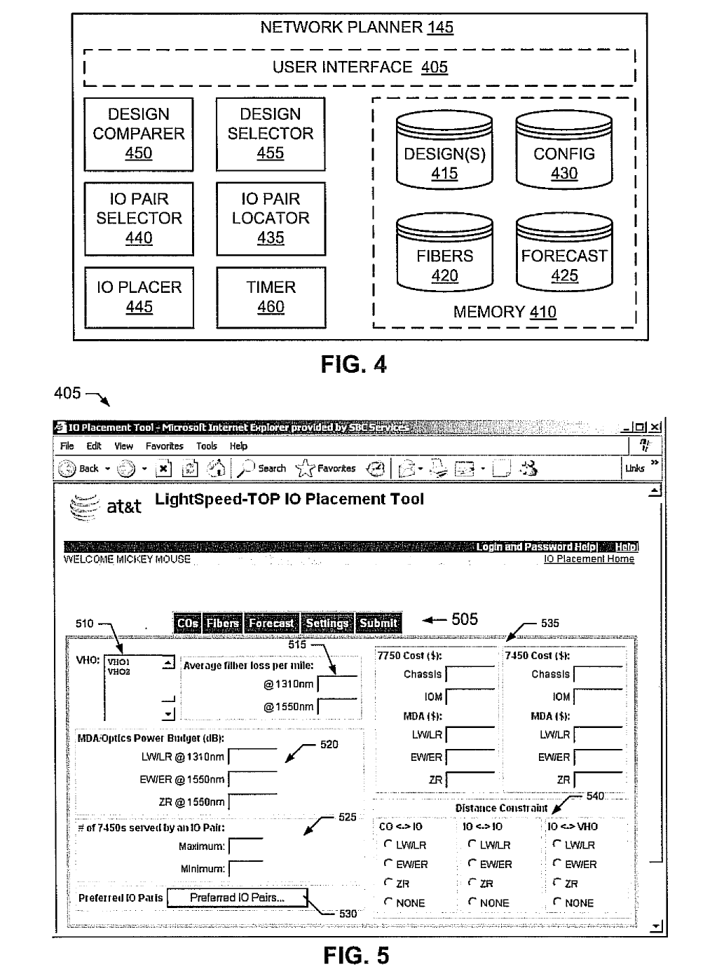

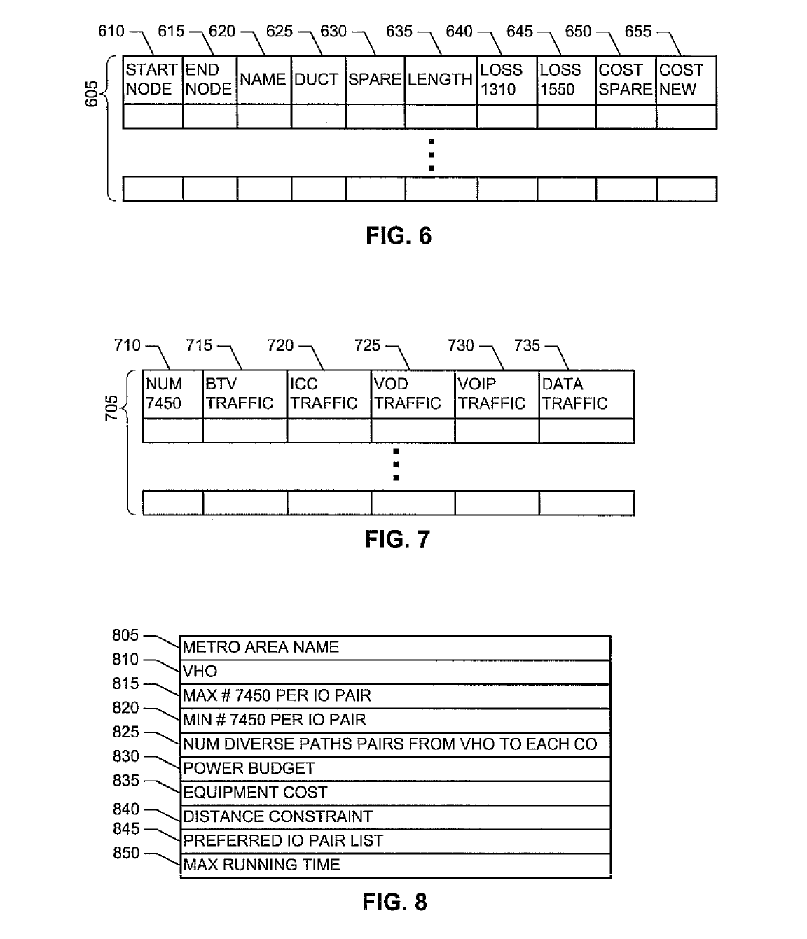

To decide which central offices are to serve as intermediate offices (i.e., which central offices are to include and/or implement an edge router 135), the example fiber-optic network of FIG. 1 includes a network planner 145. The example network planner 145 of FIG. 1 uses a list of spare and/or available fiber-optic cables of the fiber-optic network 130 and a list of forecasted traffic loads for each central office to determine which central offices are to be designated as intermediate offices. The example network planner 145 also determines which sub-tending central offices will be served by each IO pair. The example network planner 145 of FIG. 1 selects intermediate offices and/or IO pairs to meet one or more criteria, such as:
maximize network delivery coverage (e.g., most subscribers covered),
minimize overall cost including equipment cost, and/or
minimize transmission costs (e.g., smallest number of fiber-optic cables used). The network planner 145 meets these criteria given one or more constraints, such as:
topology (e.g., where are spare fiber-optic cables available),
reliability (e.g., physically diverse routing of fiber-optic cables),
equipment constraints (e.g., number of switches 140 that can be served by an edge router 135),
maximum allowable length of fiber-optic cables,
location of the VHO 115,
capacity of each fiber-optic cable,
location of central offices,
cost of fiber-optic cables, and/or
equipment costs (e.g., chassis costs, input/output module cost, fiber-optic interface costs).
   Based on the criteria and the constraints, the network planner 145 recursively traverses and/or traces a tree of network designs to identify a preferred and/or best network design. The network planner 145 specifies the preferred and/or best network design by specifying:
overall cost,
cost per IO pair,
location of edge routers 135,
fiber optic routing (i.e., paths) from switches 140 to IO pairs, from IO pairs to the VHO 115, and between the two IOs 120 of an IO pair,
bandwidth required on each path, and
signal loss for each path.
   An example recursion of a network design tree is described below in connection with FIG. 3. An example manner of implementing the network planner 145 is described below in connection with FIG. 4.

FIG. 2 illustrates an example hierarchical arrangement of a VHO (e.g., the example VHO 115 of FIG. 1), intermediate offices and central offices to deliver triple-play services. In the example arrangement of FIG. 2, the VHO 115 is coupled to one or more IO pairs, two of which are illustrated in FIG. 2 with reference numerals 205 and 206. Each of the IO pairs 205, 206 includes two intermediate offices. For example, the example IO pair 205 includes IOs 120 and 121, and the example IO pair 206 includes IOs 122 and 123. Each IO 120-123 of an IO pair 205, 206 is connected to the VHO 115 via a fiber-optic cable. For example, the IO 120 is connected to the VHO 115 via a path P1, and the IO 121 is connected to the VHO 115 via a path P2 that is constrained to be physically diverse to path P1. Moreover, the IOs 120 and 122 are connected to one another via a path P3 that, in some network designs, may be constrained to be physically diverse from paths P1 and P2.

In the example of FIG. 2, each of the IO pairs 205, 206 can serve up to eight COs 125-128. However, other numbers of COs 125-128 may be served by an IO pair (e.g., ten) depending on the particular network design constraints being applied. Each of the example COs 125-126 is connected to each IO 120-121 of its serving IO pair 205 via a physically diverse path. Similarly, each of the example COs 127-128 is connected to each IO 122-123 of its serving IO pair 206 via a physically diverse path. For example, the CO 125 is connected to the IO 120 via a path P4, and to the IO 121 via a path P5, which is physically diverse from path P4. Moreover, paths P4 and P5 are each constrained to be physically diverse from each of the paths P1, P2 and P3.

As noted above, intermediate offices are specially designated central offices. Thus, when a network is configured the example network planner 145 of FIG. 1 selects a subset of the central offices to serve as intermediate offices (e.g., the example IOs 120-123) and IO pairs (e.g., the IO pairs 205 and 206) that satisfy the path diversity constraints described above (e.g., the path P1 is physically diverse from path P2, etc.), as well as to satisfy the design criteria and constraints discussed earlier.

To identify a best and/or preferred network design, the example network planner 145 of FIG. 1 considers various combinations of IO pairs by selecting IO pairs in different orders. The various combinations of IO pairs considered by the network planner 145 can be depicted and/or represented as a network design tree, where each node of the network design tree represents a particular combination of IO pairs selected in a particular order. The example network planner 145 of FIG. 1 recursively traces the network design tree to identify the best and/or preferred network design.

FIG. 3 illustrates an example recursion of a network design tree. Each node of the example network design tree of FIG. 3 represents a particular network design. A network design (i.e., a node) may represent a complete network design (e.g., all switches 140 served by an IO pair) and/or partial network design (e.g., some COs 125 and 126 unserved and/or some switches 140 unserved). Moreover, some network designs may be more optimal than other network designs (e.g., lower cost and/or fewer unserved switches 140). In the example of FIG. 3, the example network planner 145 of FIG. 1 uses a recursive function named “PLACE IO PAIRS” to trace recursively the network design tree to explore network designs, thereby identifying a best and/or preferred (e.g., a so-called optimal) network design.

In the illustrated example of FIG. 3, each successive call of the recursive function adds and/or attempts to add an additional IO pair (e.g., one of the example IO pairs 205 and/or 206 of FIG. 2) to a previous network design. In one example, the recursive function is called until either a network design under consideration is complete and/or until an incomplete design is determined to be already less preferred and/or worse (e.g., less optimal) than a current best network design. For each potential network design (i.e., each node of the design tree), the recursive function recursively calls itself. Moreover, at each node of the design tree, the current network design is saved such that when a branch of the tree has been traversed, one or more returns from the recursive function calls allow the network planner 145 to backtrack to a previous network design (i.e., a node higher up in the network design tree). After backtracking to a previous network design, additional and/or alternative IO pairs can be added to form another network design (i.e., node) for consideration.

At each network design (e.g., each node of the design tree), the current network design is compared against the current best design. If the current network design is not complete (e.g., not all switches 140 served) and not yet worse than the current best design (e.g., the cost is still less than the current best design) another call to the recursive function is made. If the current network design is already worse or is estimated to be worse than the current best design, the recursive function stops the design of the already worse node and returns, thereby, returning to a previous node of the network design tree. If the current network design is complete and better than the current best design (e.g., serves more switches 140, uses fewer edge routers 135 and/or cost less), then the current best design is replaced with the current network design.

The example recursions of FIG. 3 begin with a first call 305 of the recursive function. During the first call 305, a first IO pair is selected to form a first network design DESIGN 310. Because the network design 310 is incomplete and does not already represent a potentially worse network design than the current best design, a second call 315 to the recursive function is made to form a second network design DESIGN_A 320. Continuing, subsequent calls 325 and 330 of the recursive function form respective network designs DESIGN_A′ 335 and DESIGN_A″ 340. Because the design DESIGN_A″ 340 is complete and better and/or preferred to the current best design, the current best design is replaced with the design DESIGN_A″ 340. Because there are no alternative network designs to consider based on the design DESIGN_A′ 335, two respective returns of the recursive function calls 330 and 325 are made to return to design DESIGN_A 320.

At node 320, subsequent calls 345 and 350 to the recursive function are made to form respective network designs DESIGN_A′″ 355 and DESIGN_A″″ 360. Because the design DESIGN_A″″ 360 is worse than the current best design (i.e., DESIGN_A″ 340), a return of the recursive function call 350 is made to return to design DESIGN_A′″ 355. From node 355, another call 365 of the recursive function is made to form network design DESIGN_A′″″ 370. Because the design DESIGN_A′″″ 370 is complete and better and/or preferred to the DESIGN_A″ 340 (i.e., the current best design), the current best design is replaced with the design DESIGN_A′″″ 370.

Because there are no additional alternative network designs to consider at the example nodes 355 and 320, three respective returns of the recursive function calls 365, 345 and 315 are made to return to the design DESIGN 310. From the node 310, yet another network design DESIGN_B 375 is formed via yet another call 380 of the recursive function. From design DESIGN_B 375 and/or design DESIGN 310, recursive tracing of the network design tree continues similarly to that described above.

Tracing of a network design tree may continue until the network design tree has been fully traced. Additionally or alternatively, the extent of the network design tree that is traced may be determined based on one or more parameters. For example, a timer may be used such that when the timer expires the current best design is selected even if the entire network design tree has not yet been traced. Additionally or alternatively, a parameter that represents the maximum depth of the tree that is be explored (e.g., the maximum number of nested times that the recursive function may be called) can be set. Further, the network tree could be traced until a “good enough” network design is identified. For example, a network design serving all of the switches 140 and having a cost less than a pre-determined value. Moreover, the network design tree may be partitioned such that the network design tree may be traced by separate computing and/or processing threads and/or processors (e.g., parallel processing). Once such partitions are traced, the best network design determined from each partition can be compared to select the best overall network design.

A network design tree may be explored using other methods and/or apparatus, such as those described in U.S. patent application Ser. No. 11/403,5110, filed on Apr. 12, 2006, and entitled “System and Method for Providing Topology and Reliability Constrained Low Cost Routing in a Network.” U.S. patent application Ser. No. 11/403,5110 is hereby incorporated by reference in its entirety.

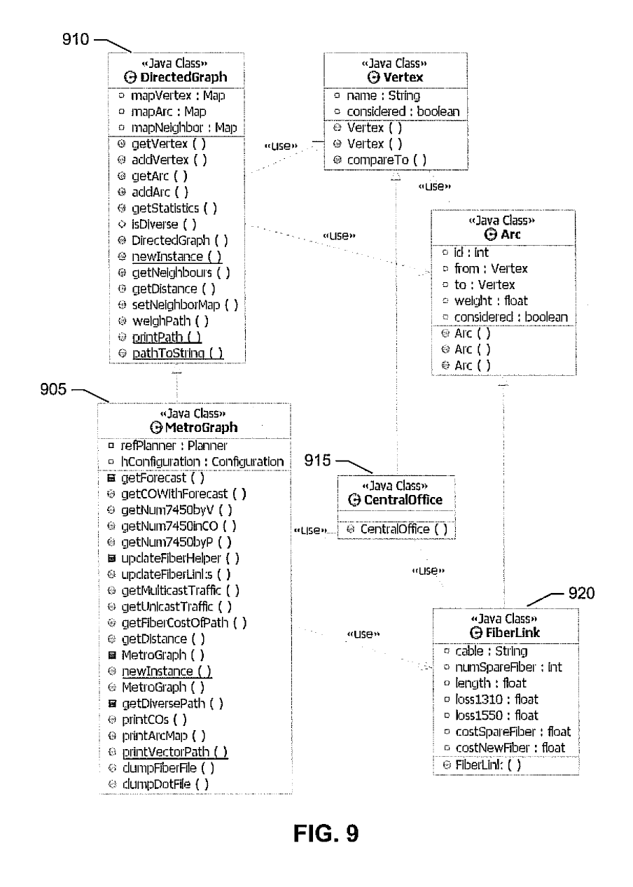

FIG. 4 illustrates an example manner of implementing the example network planner 145 of FIG. 1. So that a user may control and/or use the example network planner 145 of FIG. 4, the network planner 145 includes a user interface 405. The example user interface 405 of FIG. 4 is used to input and/or load information pertaining to a fiber optic network (e.g., the example fiber-optic network 130 of FIG. 1), traffic forecasts and/or network configuration information. An example manner of implementing the example user interface 405 is described below in connection with FIG. 5.

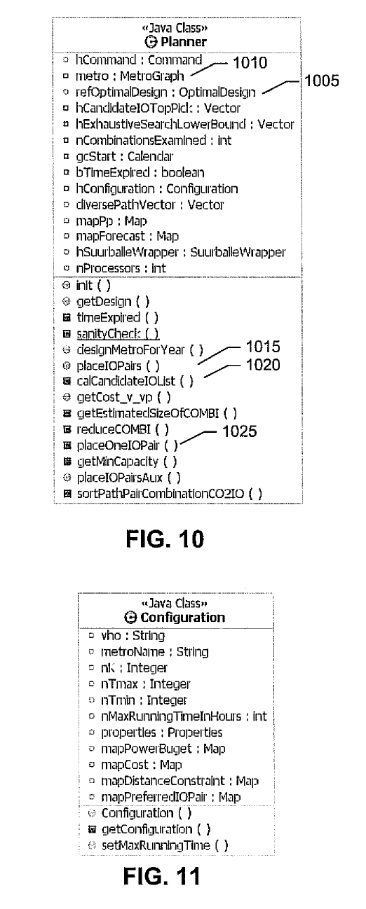

To store data and/or parameters, the example network planner 145 of FIG. 4 includes a memory 410. The example memory 410 of FIG. 4 may be implemented using any number and/or type(s) of volatile and/or non-volatile memories and/or memory devices. The example memory 410 may be used to store network designs 415, fiber-optic cable information 415, traffic forecast data 420 and/or fiber-optic network configuration parameters 425 in one or more data structures. Example data structures that may be used to implement the example fiber-optic cable information 415, the example traffic forecast data 420 and the example configuration data 430 are described below in connection with FIGS. 6, 7 and 8, respectively.

To identify potential IO pairs, the example network planner 145 of FIG. 4 includes an IO pair locator 435. Using a list of central offices and available fiber-optic cables (e.g., from the example fiber-optic cable information 420), the example IO pair locator 435 of FIG. 4 creates a list of one or more possible candidate IO pairs that may be used to serve one or more central offices. If there are preferred and/or currently in use IO pairs, the example IO pair locator 435 of FIG. 4 includes such IO pairs at the top of the candidate IO pair list. For example, a network design for a particular year may be designed based on the network design of a prior year and, thus, IO pairs selected for the prior year represent preferred IO pairs for the particular year.

To select an IO pair to place, the example network planner 145 of FIG. 4 includes an IO pair selector 440. Based on one or more criteria, the example IO pair selector 440 selects an IO pair from a list of candidate IO pairs generated by the example IO pair locator 435. For example, the IO pair selector 440 may select an IO pair having the lowest cost to serve a given number of central offices and/or an IO pair serving the most central offices.

To place a selected IO pair, the example network planner 145 of FIG. 4 includes an IO placer 445. Given a current network design, the example IO placer 445 of FIG. 4 creates and/or forms a new network design by adding the selected IO pair to the current network design. For example, the IO placer 445 determines and/or selects a set of central offices that are to be served by the IO pair, and selects fiber-optic cables between the IO pair and the selected central offices. The current network design is then copied to create the new network design and then modified to reflect the addition of the new IO pair and the set of central offices served by the IO pair. In some examples, the IO placer 445 is implemented as a recursive function and/or a function utilized by a recursive function.

To compare two network designs, the example network planner 145 of FIG. 4 includes a design comparer 450. The example design comparer 450 of FIG. 4 compares two network designs (e.g., stored in the network designs 415) by comparing one or more parameters and/or values, such as, total cost, cost per IO pair, number of unserved central offices, and/or number of unserved switches 140.

To select a network design, the example network planner 145 of FIG. 4 includes a design selector 455. The example design selector 455 of FIG. 4 compares two network designs (e.g., stored in the network designs 415) using, for example, the example design comparer 450, and selects the network design that is best, most preferred and/or most optimal. For example, the design selector 455 can use the design comparer 450 to compare a new design with the current best design and, if the new design is better and/or more preferred, replace the current best design with the new design.

To control how long the example network planner 145 of FIG. 4 executes, the network planner 145 includes any type of timer 460. The example timer 460 of FIG. 4 tracks how long the example IO placer 445 and/or, more generally, the example network planner 145 have been recursively tracing a network design tree. When a predetermined amount of time has elapsed, tracing of the network design tree is ended and the current best network design is selected by, for example, the design selector 455.

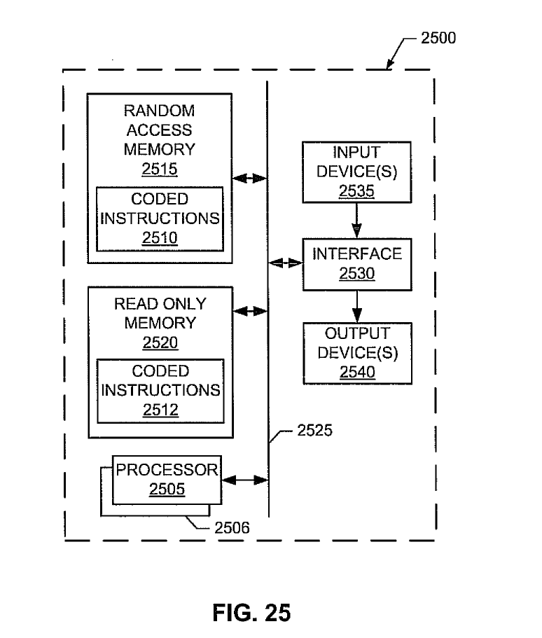

While an example manner of implementing the example network planner 145 of FIG. 1 is illustrated in FIG. 4, the network planner 145 may be implemented using any number and/or type(s) of other and/or additional logic, processors, devices, components, circuits, modules, interfaces, etc. Further, the logic, processors, devices, components, circuits, modules, elements, interfaces, etc. illustrated in FIG. 4 may be combined, divided, re-arranged, eliminated and/or implemented in any of a variety of ways. Additionally, the example network planner 145 may be implemented as any combination of firmware, software, logic and/or hardware. For example, the example user interface 405, the example IO pair locator 435, the example IO pair selector 440, the example IO placer 445, the example design comparer 450, the example design selector 455, the example timer 460 and/or, more generally, the example network planner 145 may be implemented as coded instructions (e.g., the example coded instructions 2510 and/or 2512 of FIG. 25) executed by, for example, the example processor 2505 of FIG. 25. Moreover, a network planner 145 may include additional logic, processors, devices, components, circuits, interfaces and/or modules than those illustrated in FIG. 4 and/or may include more than one of any or all of the illustrated processors, devices, components, circuits, interfaces and/or modules. For example, one or more of the example memory 410, the example IO placer 445, the example IO pair selector 440, the example IO pair locator 435, the example design comparer 450, the example design selector 455 and/or the example timer 460 may be duplicated to implement the parallel tracing of portions of a network design tree.

FIG. 5 illustrates an example manner of implementing the example user interface 405 of FIG. 4. The example user interface 405 of FIG. 5 is implemented as a web-based interface. To select which type and/or category of information is being loaded and/or entered, the example user interface 405 of FIG. 5 includes one or more tabs 505. The example tabs 505 of FIG. 5 allow a user to select a type and/or category of information (e.g., settings, fibers and/or traffic forecast).

To select a VHO, the example user interface 405 of FIG. 5 includes a list box 510 that allows a user to select the VHO. To enter fiber losses, the example user interface 405 of FIG. 5 includes one or more text entry boxes 515 that allow a user to enter average fiber loss per mile values for different wavelengths. To enter fiber-optic margins, the example user interface 405 of FIG. 5 includes one or more text entry boxes 520 that allow a user to enter the margin (in dB) for different fiber-optic interface types (e.g., LW/LR, EW/ER and/or ZR).

To enter a number of switches (e.g., the example switches 140 of FIG. 1) that may be served by an IO pair, the example user interface 405 of FIG. 5 includes one or more text boxes 525 that may be used to, for example, enter a maximum and a minimum number of switches that may be served by an IO pair.

To enter preferred IO pairs, the example user interface 405 of FIG. 5 includes a button 530. The example button 530 of FIG. 5 initiates one or more additional windows and/or user interfaces that allow a user to select and/or specify one or more central offices as preferred IO pairs and/or as already having installed edge routers 135.

To enter cost information, the example user interface 405 of FIG. 5 includes one or more text boxes 535. The example text boxes 535 of FIG. 5 can be used to enter chassis costs, input/output module costs, and/or costs per fiber-optic interface type. To specify distance constraints, the example user interface 405 of FIG. 5 includes one or more selections 540. The example selections 540 of FIG. 5 allow a user to select which fiber-optic interface type is assumed when determining the maximum distance allowed between central offices and intermediate offices, between intermediate offices, and/or between the VHO and intermediate offices.

While an example manner of implementing the example user interface 405 of FIG. 4 is illustrated in FIG. 5, persons of ordinary skill in the art will readily appreciate that the user interface 405 may be implemented using any number and/or type(s) of windows, boxes, lists and/selection elements. Moreover, a user interface 405 may include additional windows, boxes, lists and/selection elements than those illustrated in FIG. 5 and/or may include more than one of any or all of the illustrated windows, boxes, lists and/selection elements.

FIG. 6 illustrates an example data structure that may be used to implement the example fiber-optic cable information 420 of FIG. 4. The example data structure of FIG. 6 contains a plurality of entries 605 for respective ones of a plurality of fiber-optic cables.

To specify the starting and ending locations of a fiber-optic cable, each of the example entries 605 of FIG. 6 includes a start node field 610 and an end node field 615. The example start node field 610 of FIG. 6 contains a value and/or identifier of the central office where the fiber-optic cable starts, and the example end node field 615 of FIG. 6 contains a value and/or identifier of the central office where the fiber-optic cable ends.

To identify the fiber-optic cable, each of the example entries 605 of FIG. 6 includes a name field 620. The example name field 620 contains a value and/or alphanumeric string that uniquely identifies the fiber-optic cable.

To identify a duct, each of the example entries 605 of FIG. 6 includes a duct field 625. The example duct field 625 of FIG. 6 contains a value and/or alphanumeric string that uniquely identifies the duct in which the fiber-optic cable in physically located.

To identify whether the fiber-optic cable is a spare, each of the example entries 605 of FIG. 6 includes a spare field 630. The example spare field 630 of FIG. 6 contains a value and/or flag that identifies if the fiber-optic cable: a) is a spare fiber-optic cable and, thus, available for carrying triple-play service data and/or signals or b) is a new fiber-optic cable that needs to be installed.

To specify a length, each of the example entries 605 of FIG. 6 includes a length field 635. The example length field 635 of FIG. 6 contains a value that represents the physical length of the fiber optic cable.

To specify loss values, each of the example entries 605 of FIG. 6 includes a loss 1310 field 640 and a loss 1550 field 645. The example loss 1310 field 640 of FIG. 6 contains a value that represents the loss of the fiber-optic cable at a wavelength of 1310 nm. The example loss 1550 field 645 of FIG. 6 contains a value that represents the loss of the fiber-optic cable at a wavelength of 1550 nm.

To specify cost values, each of the example entries 605 of FIG. 6 includes a cost spare field 650 and a cost new field 655. The example cost spare field 650 contains a value that represents the cost of the fiber-optic cable as a spare fiber-optic cable. The example cost new field 655 contains a value that represents the cost of installing the fiber-optic cable as a new fiber-optic cable.

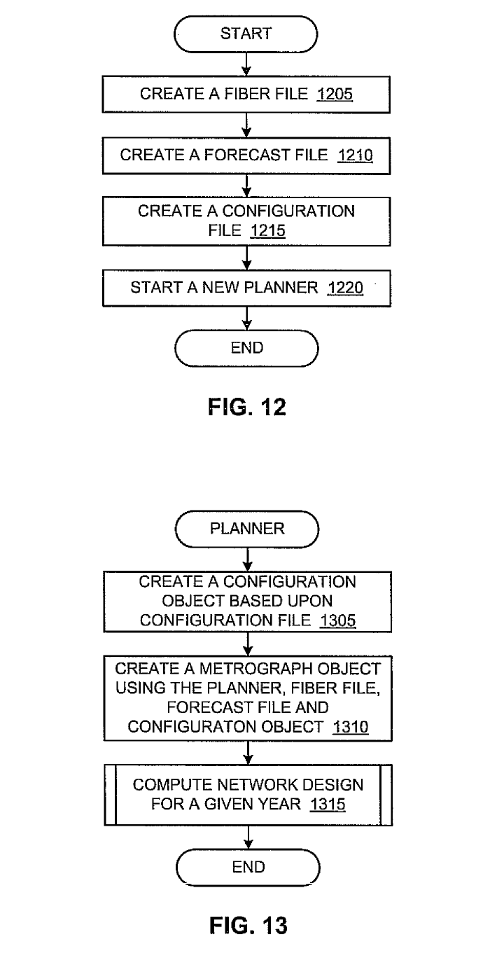

FIG. 7 illustrates an example data structure that may be used to implement the example traffic forecast data 425 of FIG. 4. The example data structure of FIG. 7 contains a plurality of entries 705 for respective ones of a plurality of central offices (e.g., the example COs 120, 125 and 126 of FIG. 1).

To specify a number of switches, each of the example entries 705 of FIG. 7 includes a number 7450 field 710. The example number 7450 field 710 of FIG. 7 contains a value that represents the number of service switches (e.g., Alcatel 7450 switches) implemented at the central office.

To specify traffic forecasts, each of the example entries 705 of FIG. 7 include traffic forecast fields 715, 720, 725, 730 and 735. The example traffic forecast fields 715, 720, 725, 730 and 735 contain values that represent a forecast broadcast television (BTV) data, forecast instant channel change (ICC) data, forecast video on demand (VoD) data, voice over Internet protocol (VoIP) data and high-speed Internet data, respectively.

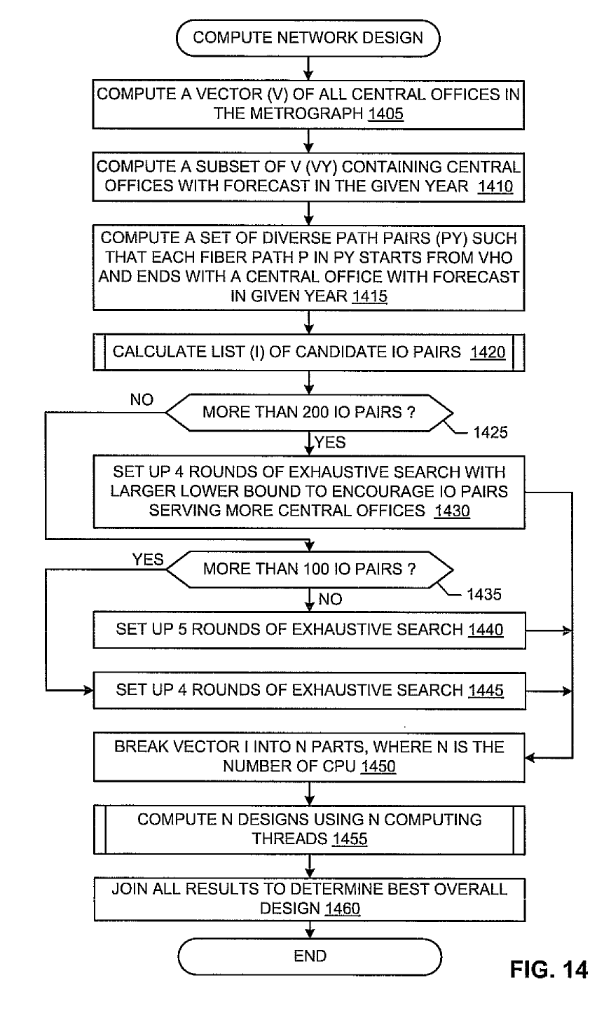

FIG. 8 illustrates an example data structure that may be used to implement configuration data for a fiber-optic network (e.g., the example configuration data 430 of FIG. 4). The example data structure of FIG. 8 may be created using, for example, the example user interface 405 of FIG. 5. To specify a metropolitan area name, the example data structure of FIG. 8 includes a metro area name field 805. The example metropolitan area name field 805 of FIG. 8 contains an alphanumeric string that represents the name of a metropolitan area.

To specify a VHO, the example data structure of FIG. 8 includes a VHO field 810. The example VHO field 810 of FIG. 8 contains an alphanumeric string that uniquely identifies the VHO (e.g., the example VHO 115 of FIG. 1) that serves the metropolitan area.

To specify a number of switches, the example data structure of FIG. 8 includes a maximum field 815 and a minimum field 820. The example maximum field 815 and the example minimum field 820 of FIG. 8 contain values that, respectively, represent the maximum number of switches (e.g., Alcatel 7450 service switches) and the minimum number of switches that may be served by an IO pair.

To specify power budgets, the example data structure of FIG. 8 includes a power budget field 830. The example power budget field 830 of FIG. 8 contains one or more values that represent the allowable transmit power for different fiber-optic interface types.

To specify equipment costs, the example data structure of FIG. 8 includes an equipment cost field 835. The example equipment cost field 835 of FIG. 8 contains one or more values that represent the cost of equipment chassis, input/output module and/or fiber-optic interfaces.

To specify a distance constraint, the example data structure of FIG. 8 contains a distance constraint field 840. The example distance constraint field 840 of FIG. 8 contains one or more values that represent which type of fiber-optic interface is used when determining the maximum length of a fiber-optic cable.

To specify preferred IO pairs, the example data structure of FIG. 8 includes a preferred IO pair list field 845. The example preferred IO pair list field 845 contains one or more values and/or alphanumeric strings that represent one or more preferred IO pairs.

To specify a running time, the example data structure of FIG. 8 includes a maximum running time field 850. The example maximum running time field 850 of FIG. 8 contains a value that represents the maximum running time for the network planner 145 to determine a network design.

While an example data structures are illustrated in FIGS. 6, 7 and 8, the example data structures may be implemented using any number and/or type(s) of other and/or additional fields and/or data. Further, the fields and/or data illustrated in FIGS. 6, 8 and/or 8 may be combined, divided, re-arranged, eliminated and/or implemented in any of a variety of ways. Moreover, the example data structures may include additional fields and/or data than those illustrated in FIGS. 6, 7 and/or 8 and/or may include more than one of any or all of the illustrated fields and/or data.

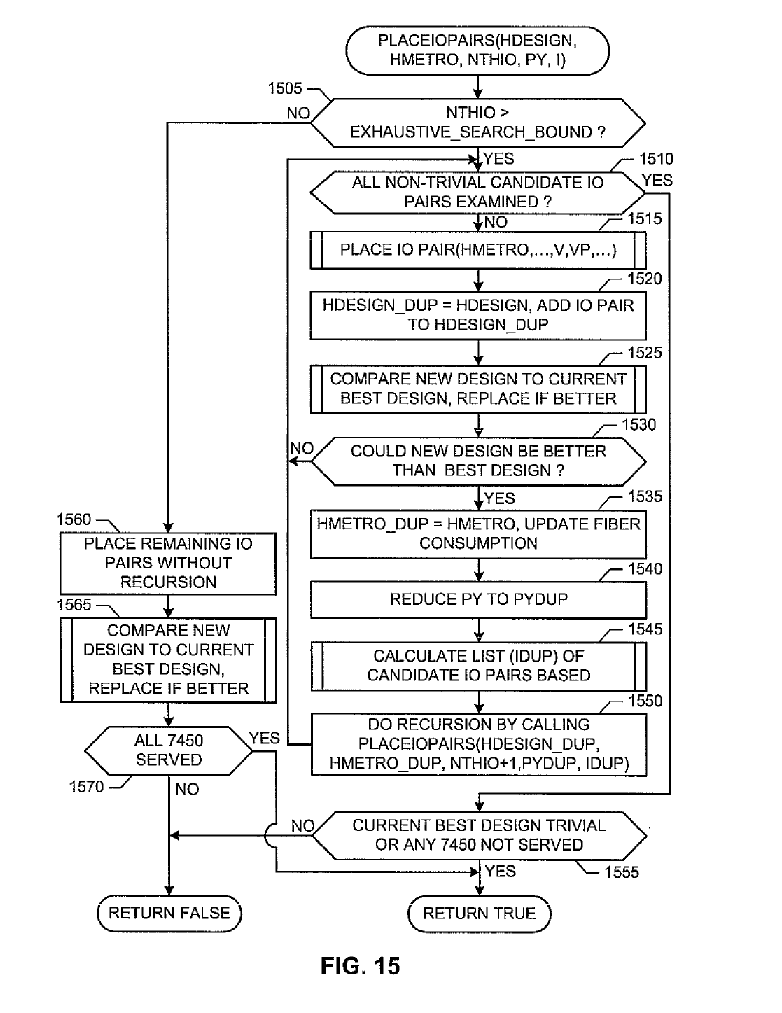

FIG. 9 illustrates example class objects that may be used to represent a fiber-optic network (e.g., the example fiber-optic network 130 of FIG. 1). To represent a network design, the example class objects of FIG. 9 use a MetroGraph class 905. The example MetroGraph class 905 of FIG. 9 represents a fiber-optic network using one or more instances of a DirectedGraph class 910, a CentralOffice class 915 and a FiberLink Class 920.

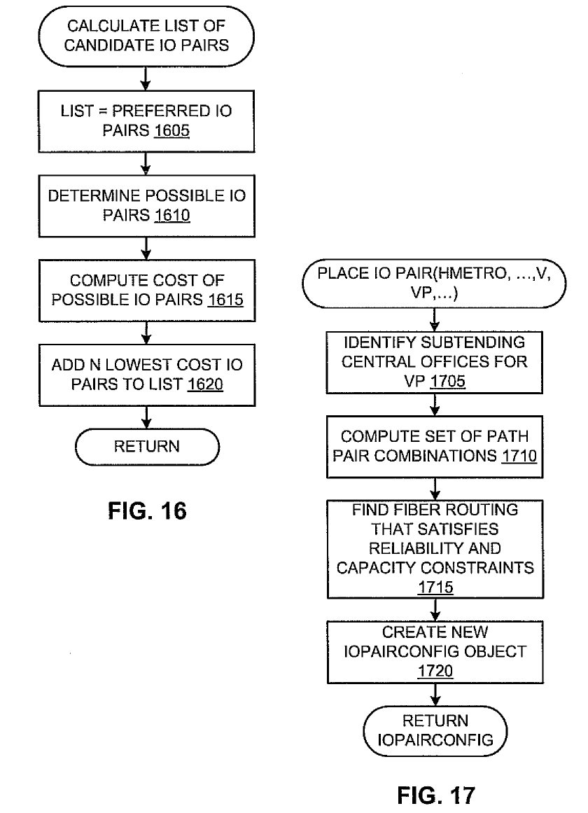

FIG. 10 illustrates an example class object that may be used to implement the example network planner 145 of FIG. 1. The example Planner class of FIG. 10 includes, among other things, a reference 1005 to a current best design, and a reference 1010 a MetroGraph class (e.g., the example Metrograph class 905 of FIG. 9) that represents the fiber-optic network to be designed. The example Planner class also includes a recursive function 1015 names placeIOPairs( ) that traces a network design tree to locate a best, preferred and/or optimal network design. As described below, the placeIOPairs( ) function 1015 utilizes other functions of the Planner class, such as calCandidateIOList( ) 1020 and placeoneIOPair( ) 1025.

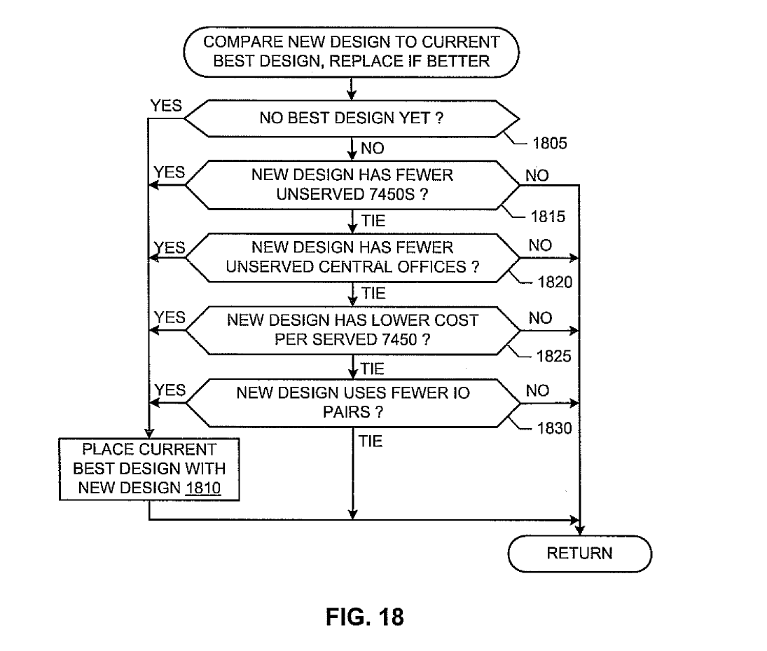

FIG. 11 illustrates an example class object that may be used to implement the example network planner 145 of FIG. 1 and/or, more particular, the example configuration data 430 of FIG. 4 and/or the example data structure of FIG. 8.

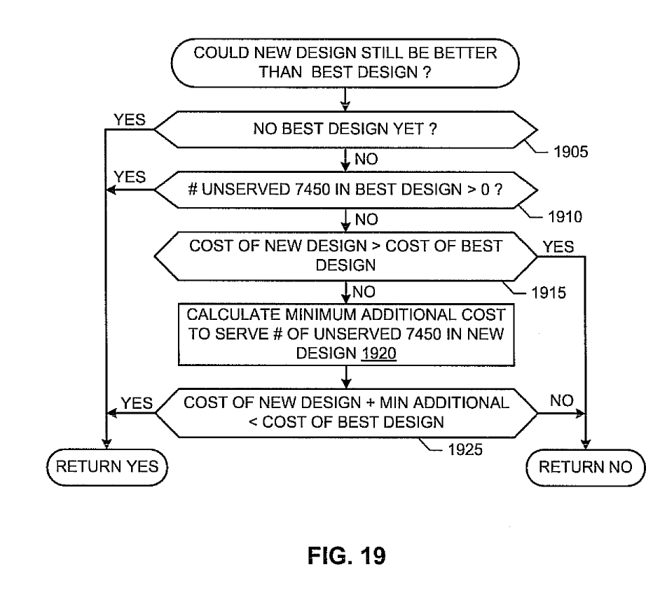

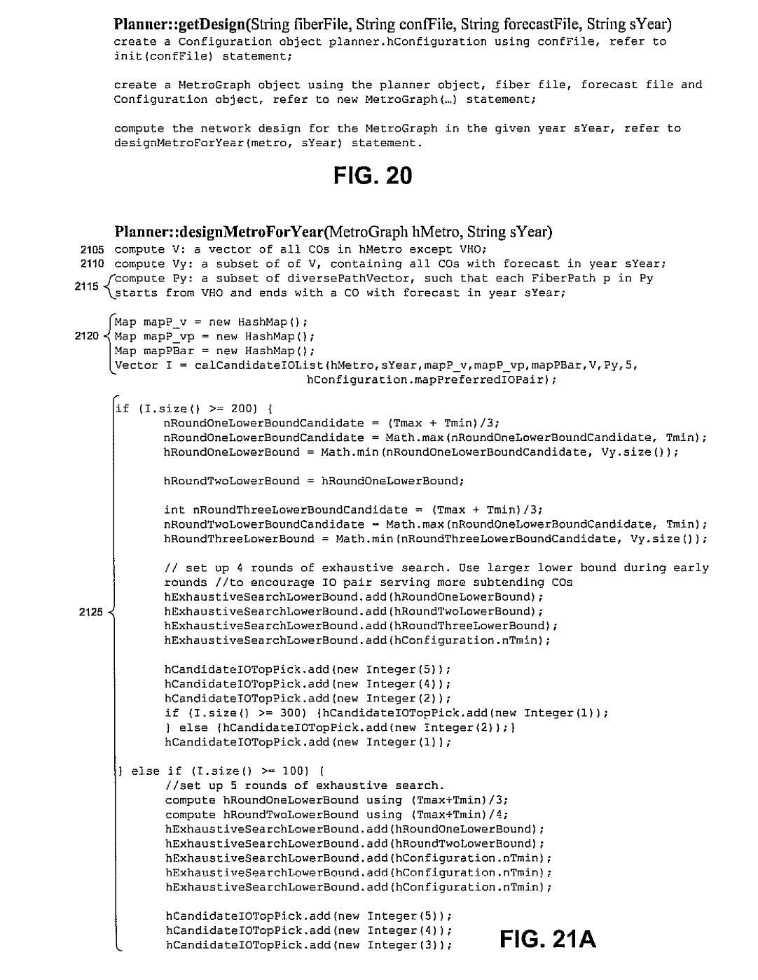

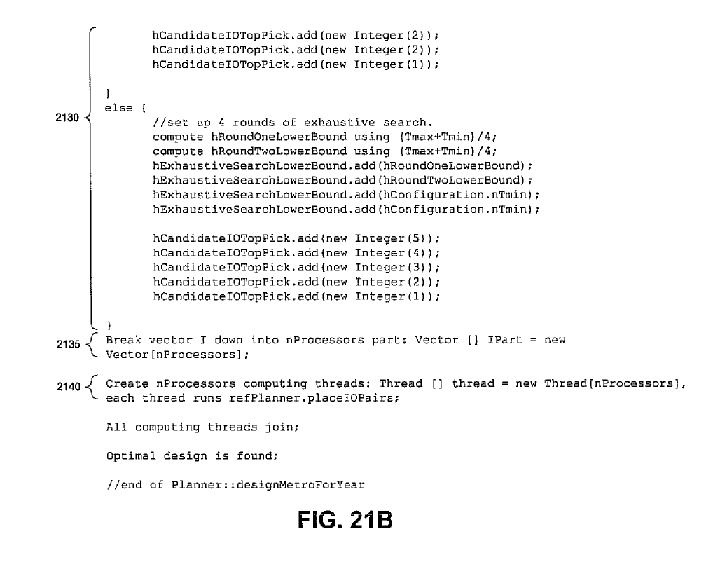

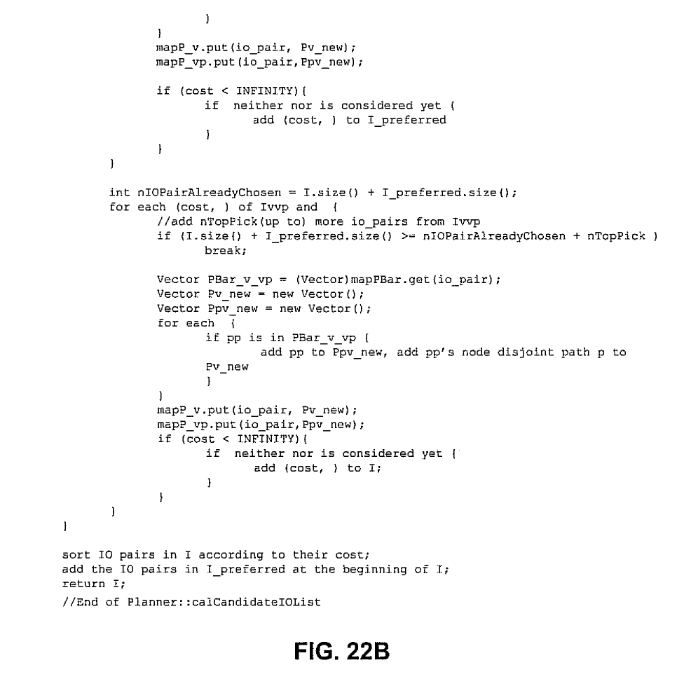

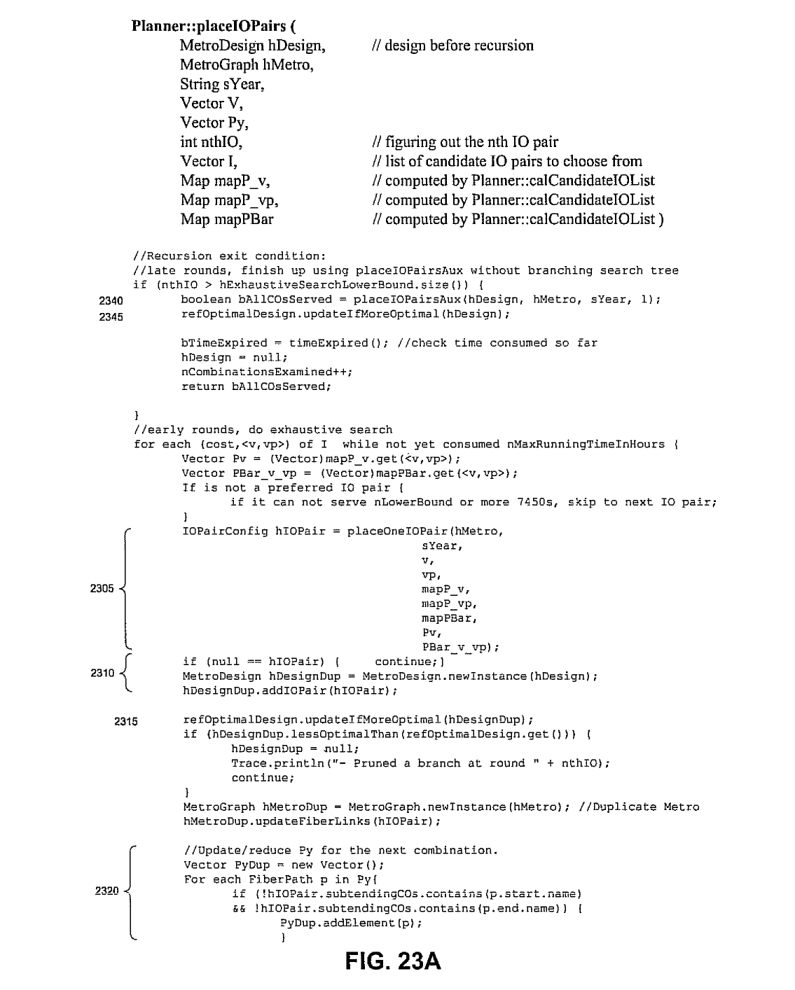

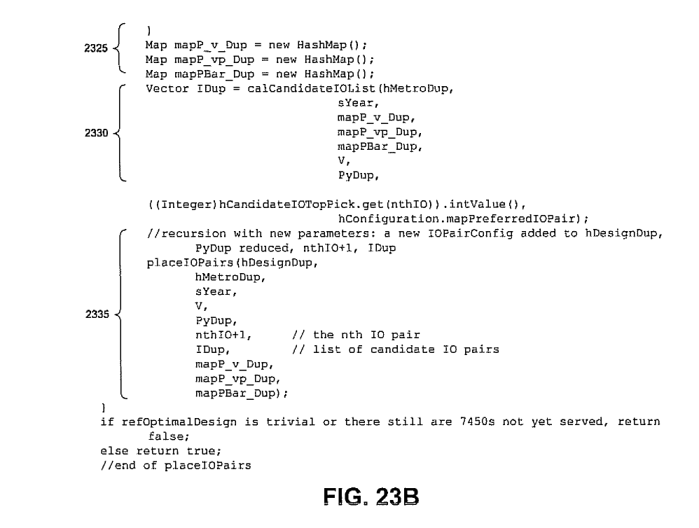

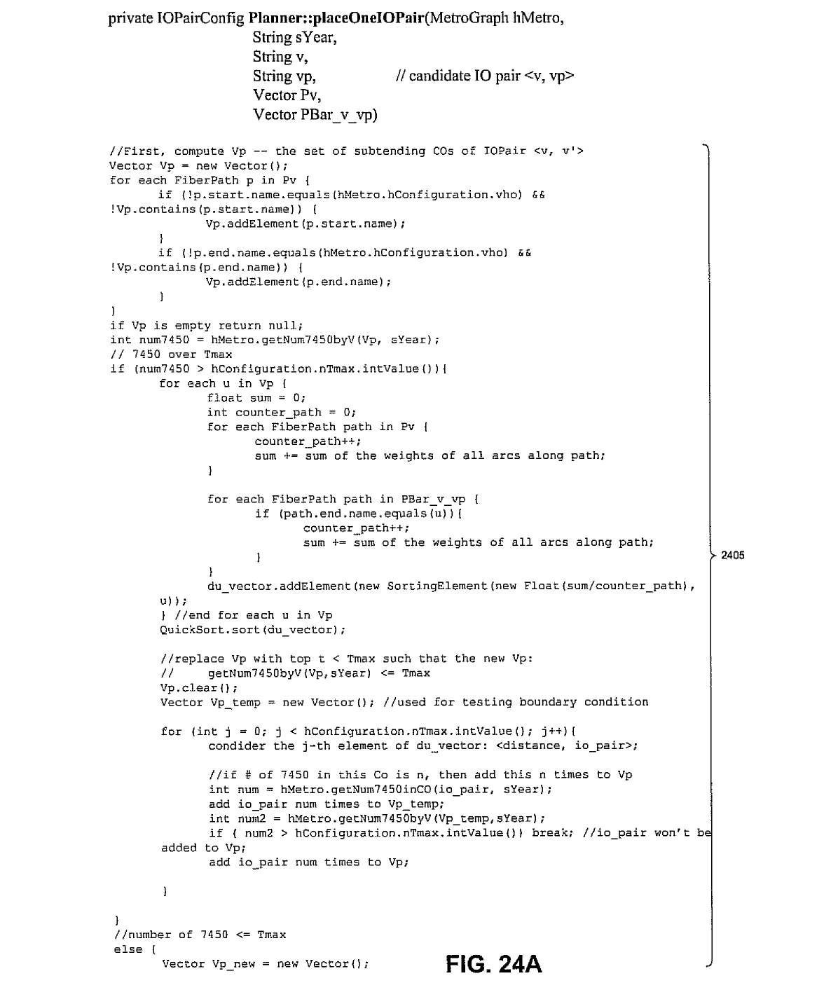

FIG. 12 is a flowchart representative of an example process that may be carried out to design a fiber-optic network. FIGS. 13, 14 and/or 15 are flowcharts representative of an example process that may be carried out to implement the example network planner 145 of FIGS. 1 and/or 4. FIG. 16 is a flowchart representative of an example process that may be carried out to implement the example IO pair locator 435 of FIG. 4. FIG. 17 is a flowchart representative of an example process that may be carried out to implement the example IO placer 445 of FIG. 4. FIG. 18 is a flowchart representative of an example process that may be carried out to implement the example design selector 455 of FIG. 4. FIG. 19 is a flowchart representative of an example process that may be carried out to implement the example design comparer 450 of FIG. 4.

The example processes of FIGS. 12-18 may be carried out by a processor, a controller and/or any other suitable processing device. For example, the example processes of FIGS. 12-18 may be embodied in coded instructions stored on a tangible medium such as a flash memory, a read-only memory (ROM) and/or random-access memory (RAM) associated with a processor (e.g., the example processor 2505 discussed below in connection with FIG. 25). Alternatively, some or all of the example processes of FIGS. 12-18 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 12-18 may be implemented manually or as any combination(s) of any of the foregoing techniques, for example, any combination of firmware, software, discrete logic and/or hardware. Further, although the example processes of FIGS. 12-18 are described with reference to the flowcharts of FIGS. 12-18 persons of ordinary skill in the art will readily appreciate that many other methods of implementing the example methods and apparatus described herein may be employed. For example, the order of execution of the blocks may be changed, and/or some of the blocks described may be changed, eliminated, sub-divided, or combined. Additionally, persons of ordinary skill in the art will appreciate that any or all of the example processes of FIGS. 12-18 may be carried out sequentially and/or carried out in parallel by, for example, separate computing threads, processing threads, processors, devices, discrete logic, circuits, etc.

The example process of FIG. 12 begins with the creation of a file containing fiber-optic cable information (e.g., the example fiber-optic cable information 420 of FIG. 4) (block 1205). The fiber-optic cable information file may be created using any type of tool, such as one based on the example user interface 405 of FIG. 5. The fiber-optic cable information file may be implemented using the example data structure of FIG. 6.

A file containing traffic forecast data is created (block 1210). The traffic forecast data file may be implemented using the example data structure of FIG. 7. A file containing configuration data and/or parameters is created (block 1215). The configuration data file may be created using any type of tool, such as the example user interface 405 of FIG. 5. The configuration data file may be implemented using the example data structure of FIG. 8.

A network design is then generated (block 1220). The initiation of network designing may be caused by, for example, using the example user interface 405 of FIG. 5 to create the example Planner class object of FIG. 10. Additionally or alternatively, a network design can be generated by initiating and/or carrying out the example process of FIG. 13. Control then exits from the example process of FIG. 12.

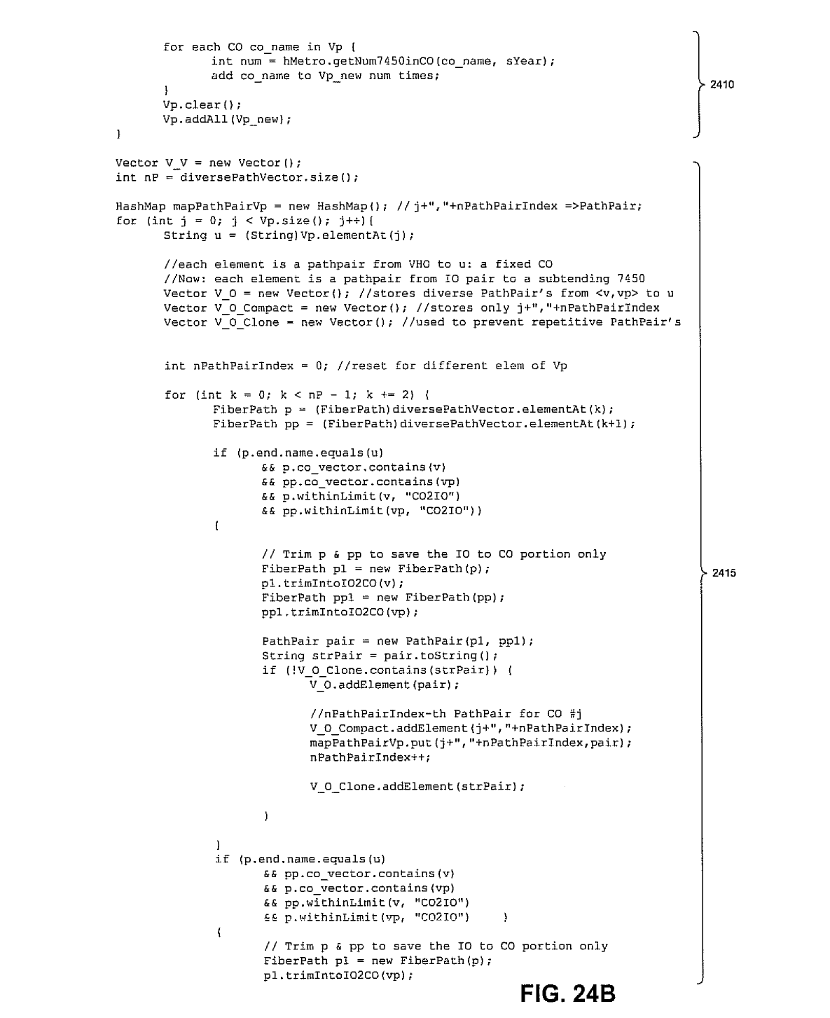

The example process of FIG. 13 begins when, for example, the example Planner class object of FIG. 10 is instantiated. The Planner creates and/or instantiates a configuration object (e.g., the example Configuration object of FIG. 11) (block 1305). Based upon a fiber-optic cable information file, a traffic forecast file and the configuration object, the Planner creates and/or instantiates a Metrograph object (e.g. the example Metrograph object 905 of FIG. 9) (block 1310). The Planner computes a network design by, for example, carrying out the example process of FIG. 14 (block 1315). Control then exits from the example process of FIG. 13. The example pseudo-code of FIG. 20 may be used to implement the example process of FIG. 13.

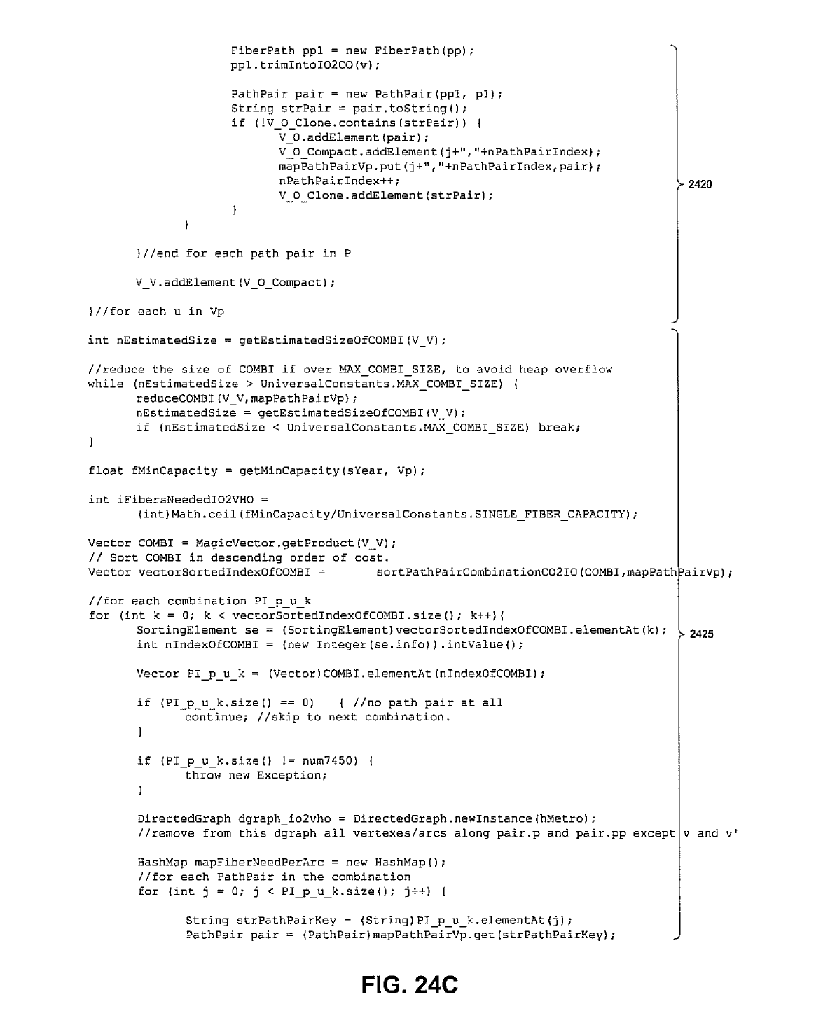

The example process of FIG. 14 may be carried out to implement the example network planner 145 of FIGS. 1 and/or 4. The example process of FIG. 14 begins with the computation of a vector V that represents all central offices of the Metrograph object by, for example, implementing line 2105 of the example pseudo-code of FIG. 21A (block 1405). A subset Vy of the vector V that represents the central offices having forecasted traffic in the year for which the network design is being generated is determined by, for example, implementing line 2110 of the example pseudo-code of FIG. 21A (block 1410). A set of physically diverse path pairs Py such that each fiber-optic path P in Py starts from the VHO of the Metrograph and ends on one of the central offices in the subset Vy is determined by, for example, implementing lines 2115 of the example pseudo-code of FIG. 21A (block 1415).

A list I of candidate IO pairs is calculated based on the set of physically diverse pairs Py by, for example, carrying out the example process of FIG. 16 and/or by implementing lines 2120 of the example pseudo-code of FIG. 21A (block 1420). If there are more than 200 IO pairs in the list I (block 1425), the configuration of the recursive function that traces the network design tree is set for a maximum tree depth of four and for a larger minimum number of central offices that must be served by each IO pair (block 1430). Control then proceeds to block 1450.

If there are more than 100 IO pairs in the list I (block 1435), the configuration of the recursive function that traces the network design tree is set for a maximum tree depth of four (block 1440). Control then proceeds to block 1450.

If there are fewer than 100 IO pairs in the list I (block 1435), the configuration of the recursive function that traces the network design tree is set to not limit the maximum tree depth (block 1445). The example blocks 1430, 1435, 1440, 1445 and 1450 of FIG. 14 may be performed by, for example, implementing example lines 2125 and 2130 of FIGS. 21A and 21B.

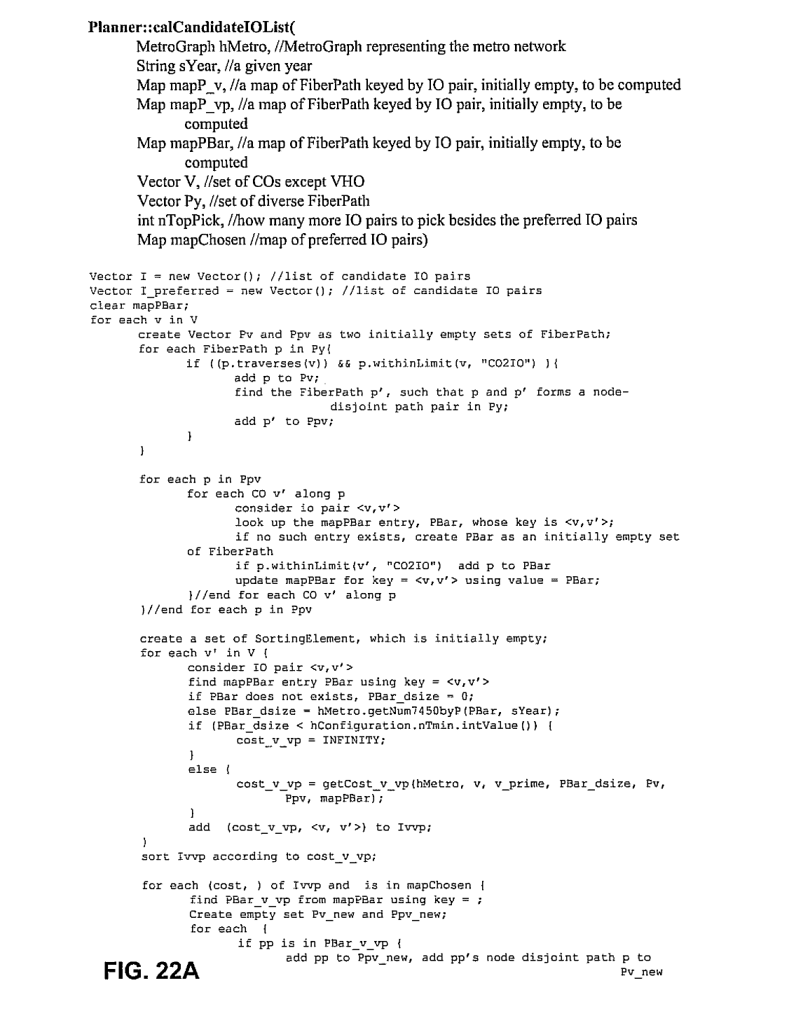

Continuing at block 1450, the IO pair list I is broken into N portions by, for example, implementing lines 2135 of the example pseudo-code of FIG. 21A (block 1450). The number N of portions is selected based on the number of computing threads and/or processors used to trace the network design tree. Each of the N portions are traced in parallel by, for example, carrying out the example process of FIG. 15 and/or by implementing lines 2140 of the example pseudo-code of FIG. 21A in N separate processing threads and/or on N separate processors (block 1455).

After each of the N portions of the network design tree have been traced, the best network designs from the portions are compared to select the best overall network design (1460) and control exits from the example process of FIG. 14.

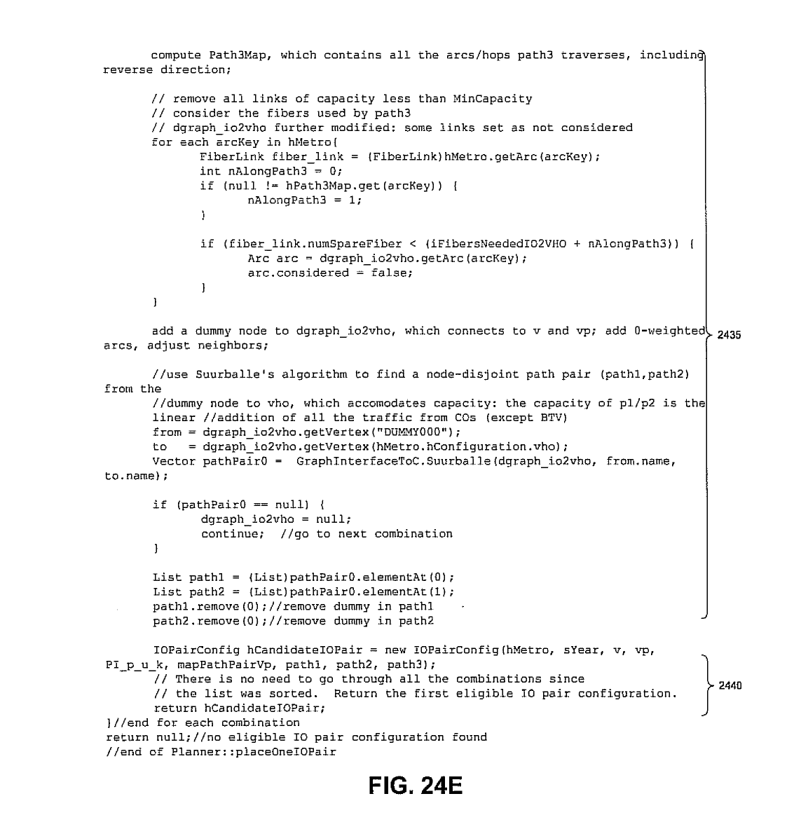

The example process of FIG. 15 implements a recursive process to place 10 pairs to trace a network design tree. The example process begins with determining if the maximum depth of recursive tracing EXHAUSTIVE_SEARCH_BOUND has been reached (block 1505). If the maximum tree depth has not been reached (block 1505) and if one or more non-trivial candidate IO pairs have not been examined (block 1510), an IOPair configuration object is created for a candidate IO pair by, for example, carrying out the example process of FIG. 17 and/or lines 2305 of the example pseudo-code of FIG. 23A (block 1515). The current design HDESIGN is duplicated and the created IOPair configuration object is added to the duplicated design object HDESIGN_DUP by, for example, implementing lines 2310 of the example pseudo-code of FIG. 23A (block 1520). The creation of the duplicate design object HDESIGN_DUP allows the recursive placing of IO pairs to return to the current design once the current tree branch has been traced.

The new design HDESIGN_DUP is compared to the current best design and if, the new design is better the best design if replaced with the HDESIGN_DUP by, for example, carrying out the example process of FIG. 18 and/or line 2315 of the example pseudo-code of FIG. 23A (block 1525).

If the new design could still (e.g., when complete) be better than the current best design (block 1530), the current MetroGraph is duplicated and fiber-optic consumption is updated based on the new IO Pair (block 1535). The current list of physically diverse paths Py is duplicated and reduced based on the newly placed IO pair by, for example, implementing lines 2320 and 2325 of the example pseudo-code of FIGS. 23A and 23B (block 1540). A new list of candidate IO pairs is computed based on the new list of physically diverse paths PyDup by, for example, carrying out the example process of FIG. 16 and/or lines 2330 of the example pseudo-code of FIG. 23B (block 1545).

The next level of the network design tree is traversed by, for example, recursively carrying out the example process of FIG. 15 and/or lines 2335 of the example pseudo-code of FIG. 23B (block 1550). When the recursive function call made at block 1550 returns, control returns to block 1510 to determine if more non-trivial 10 candidate pairs remain to be examined.

Returning to block 1510, when all non-trivial candidate IO pairs have been examined (block 1510), a determination is made whether the current best design is trivial or does not serve at least one switch (e.g., one of the Alcatel 7450 service switches 140) (block 1555). If the current best design is trivial or does not serve all of the switches (block 1555), the example process of FIG. 15 returns with a return value of TRUE. Otherwise, the example process of FIG. 15 returns with a return value of FALSE.

Returning to block 1505, if the network design tree has been recursively traced to a maximum configured depth (block 1505), one or more IO Pairs are added to the current design to complete the current design by, for example, implementing line 2340 of the example pseudo-code of FIG. 23A (block 1560). The IO Pairs are added at block 1560 without the use of recursion. For example, the IO Pairs may simply be added in the order of lowest cost. The resulting new design is compared to the current best design and if, the new design is better the best design, is replaced with the new design by, for example, carrying out the example process of FIG. 18 and/or line 2345 of the example pseudo-code of FIG. 23A (block 1565). If the new design serves all of the switches (block 1570), control returns from the example process of FIG. 15 with a return value of TRUE. If the new design does not serve all of the switches (block 1570), control returns from the example process of FIG. 15 with a return value of FALSE.

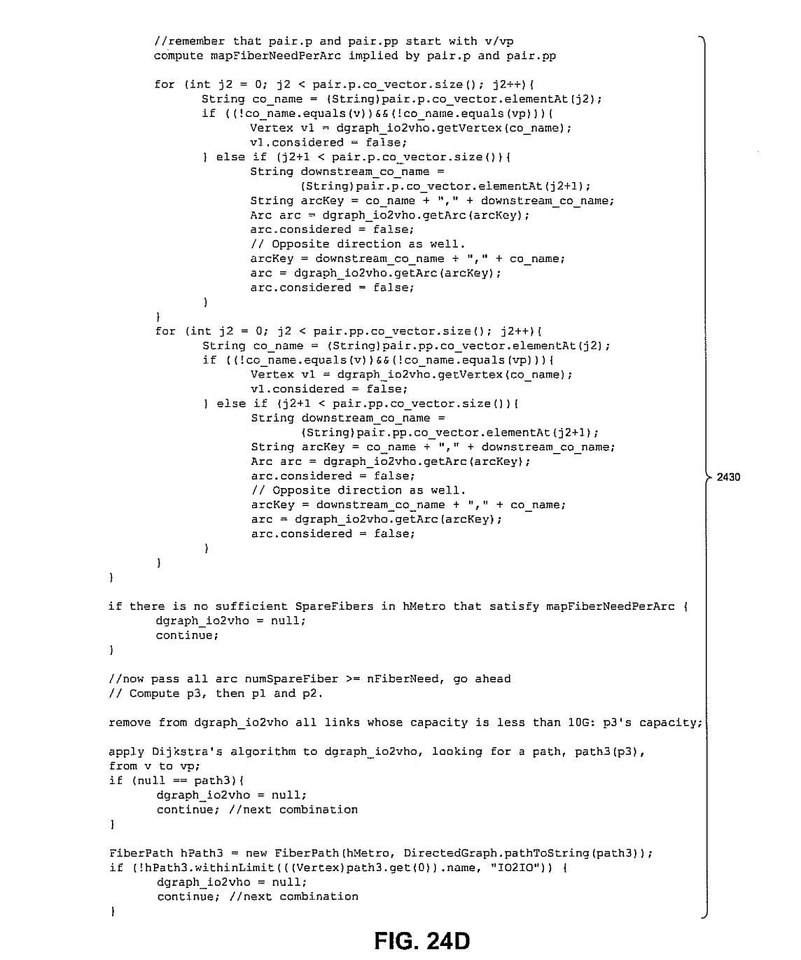

FIG. 16 is a flowchart representative of an example process that may be carried out to implement the example IO pair locator 435 of FIG. 4. The example process of FIG. 16 may be carried out, for example, by implementing the example pseudo-code of FIGS. 22A and 22B. The process of FIG. 16 begins when called by, for example, the example process of FIG. 14 at block 1420 and/or the example process of FIG. 15 at block 1545. Any preferred IO pairs are added to the top of the candidate IO Pairs list (block 1605). Based on, for example, one or more path diversity constraints, a list of possible IO pairs is computed (block 1610) and the cost of each possible IO pair is computed (block 1615). The N lowest cost IO pairs are added to the list of candidate IO Pairs (block 1620). Control then returns from the example process of FIG. 16 to the calling process and returns the candidate IO pairs list.

FIG. 17 is a flowchart representative of an example process that may be carried out to implement the example IO placer 445 of FIG. 4. The example process of FIG. 17 begins when called by, for example, the example process of FIG. 15 at block 1515. The example process of FIG. 17 determines which central offices may be served by an IO pair Vp.

For the IO pair Vp, a list of sub-tending central offices is created by, for example, implementing lines 2405 and 2410 of the example pseudo-code of FIGS. 24A and 24B (block 1705). A set of physically diverse path pair combinations is created by, for example, implementing lines 2415 and 2420 of the example pseudo-code of FIGS. 24B and 24C (block 1710). Based on the list of sub-tending central offices and the set of physically diverse path pair combinations, a set of fiber-optic cables that meet the physical diversity constraints are selected by, for example, implementing lines 2425, 2430 and 2435 of the example pseudo-code of FIGS. 24C, 24D and 24E (block 1715). An IOPair configuration object is created that specifies the sub-tending central offices and the selected fiber-optic cables by, for example, implementing lines 2440 of the example pseudo-code of FIG. 24E (block 1720). Control then returns from the example process of FIG. 17 to the calling process and returns the IOPair configuration object.

FIG. 18 is a flowchart representative of an example process that may be carried out to implement the example design selector 455 of FIG. 4. The example process of FIG. 18 begins when called by, for example, the example process of FIG. 15 at block 1525 and/or block 1565. If there is no current best design (block 1805), the new design is saved as the current best design (block 1810). Control then returns from the example process of FIG. 18.

If there is a current best design (block 1805), the number of unserved switches in the new design is compared to the number of unserved switches in the current best design (block 1815). If the new design has fewer unserved switches (block 1815), the current best design is replaced with the new design (block 1810). If the new design has more unserved switches (block 1815), control returns from the example process of FIG. 18 without replacing the current best design.

If the new design and the current best design have the same number of unserved switches (block 1815), the number of unserved central offices in the new design is compared to the number of unserved central offices in the current best design (block 1820). If the new design has fewer unserved central offices (block 1820), the current best design is replaced with the new design (block 1810). If the new design has more unserved central offices (block 1820), control returns from the example process of FIG. 18 without replacing the current best design.

If the new design and the current best design have the same number of unserved central offices (block 1820), the cost per switch for the new design is compared to the cost per switch of the current best design (block 1825). If the new design has a lower cost per switch (block 1825), the current best design is replaced with the new design (block 1810). If the new design has a higher cost per switch (block 1825), control returns from the example process of FIG. 18 without replacing the current best design.

If the new and the current best design have the same cost per switch (block 1825), the number of IO pairs used in the new design is compared to the number of IO pairs used in the current best design (block 1830). If the new design uses fewer IO pairs (block 1830), the current best design is replaced with the new design (block 1810). If the new design uses the same or more IO pairs (block 1830), control returns from the example process of FIG. 18 without replacing the current best design.

FIG. 19 is a flowchart representative of an example process that may be carried out to implement the example design comparer 450 of FIG. 4. The example process of FIG. 19 begins when called by, for example, the example process of FIG. 15 at block 1530. If there is no current best design (block 1905), then control returns from the example process of FIG. 19 with a return value of YES.

If there is a current best design (block 1905) and if there are unserved switches in the current best design (block 1910), then control returns from the example process of FIG. 19 with a return value of YES.

If there are no unserved switches in the current best design (block 1910), the current cost of the new design is compared to the cost of the current best design (block 1915). If the cost of the new design is greater than the cost of the current best design (block 1915), then control exits from the example process of FIG. 19 with a return value of NO.

If the current cost of the new design is less than the cost of the current best design (block 1915), the minimum additional cost required to serve any remaining switches is computed (block 1920). If the cost of the new design plus the minimum additional cost is less than the cost of the current best design (block 1925), then control exits from the example process of FIG. 19 with return value of YES. If the cost of the new design plus the minimum additional cost is not less than the cost of the current best design (block 1925), then control exits from the example process of FIG. 19 with return value of NO.

FIG. 25 is a schematic diagram of an example processor platform 2500 that may be used and/or programmed to implement all or a portion of the example network planner 145 of FIGS. 1 and/or 4. For example, the processor platform 2500 can be implemented by one or more general purpose processors, processor cores, microcontrollers, etc.

The processor platform 2500 of the example of FIG. 25 includes one or more programmable processors and/or processor cores, two of which are respectively illustrated in FIG. 25 with reference numerals 2505 and 2506. The processors 2505 and 2506 execute coded instructions 2510 and/or 2512 present in a main memory of the processors 2505 and 2506 (e.g., within a RAM 2515 and/or a ROM 2520). The processors and/or processor cores 2505 and 2506 may be any type of processing units, such processor cores, processors and/or microcontrollers. The processors 2505 and 2506 may execute, among other things, the example processes of FIGS. 12-19 to implement the example network planner 145 described herein. Moreover, the processors 2505 and 2506 may execute substantially similar machine accessible instructions that allow the example processors 2505 and 2506 to trace a portion of a network design tree in parallel using separate computing threads. The processors 2505 and 2506 are in communication with the main memory (including a ROM 2520 and/or the RAM 2515) via a bus 2525. The RAM 2515 may be implemented by DRAM, SDRAM, and/or any other type of RAM device, and ROM may be implemented by flash memory and/or any other desired type of memory device. Access to the memory 2515 and 2520 maybe controlled by a memory controller (not shown). The RAM 2515 may be used to store and/or implement, for example, one or more audible messages used by an interactive voice response system and/or one or more user interfaces.

The processor platform 2500 also includes an interface circuit 2530. The interface circuit 2530 may be implemented by any type of interface standard, such as an external memory interface, serial port, general purpose input/output, etc. One or more input devices 2535 and one or more output devices 2540 are connected to the interface circuit 2530. The input devices 2535 and/or output devices 2540 may be used to, for example, implement the example user interface 405 of FIGS. 4 and/or 5.

Of course, persons of ordinary skill in the art will recognize that the order, size, and proportions of the memory illustrated in the example systems may vary. Additionally, although this patent discloses example systems including, among other components, software or firmware executed on hardware, it will be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, persons of ordinary skill in the art will readily appreciate that the above described examples are not the only way to implement such systems.

At least some of the above described example methods and/or apparatus are implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of the invention are not limited to such devices, standards and/or protocols. Such systems are periodically superseded by faster or more efficient systems having the same general purpose. Accordingly, replacement devices, standards and/or protocols having the same general functions are equivalents which are intended to be included within the scope of the accompanying claims.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. An apparatus comprising:
a memory to store a first list of available fibers between a plurality of nodes of a fiber-optic network and a second list of forecasted services for the plurality of nodes; and
a network planner to recursively trace a network design tree to identify a preferable network design based on the first and the second lists.

2. An apparatus as defined in claim 1, wherein the network planner comprises:
a second memory to store a first network design and a presently preferred network design;
a network design comparer to compare the first network design to the presently preferred network design and to replace the presently preferred network design with the first network design when the first network design is potentially preferred to the presently preferred network design.

3. An apparatus as defined in claim 1, wherein the network planner comprises:
an intermediate office (IO) pair selector to select an IO pair from a list of candidate IO pairs; and
an IO placer adds the selected IO pair to a first network design to form a second network design when the first network design is potentially preferred to a presently preferred network design.

4. An apparatus as defined in claim 3, wherein the IO pair selector is to select a second IO pair from the list of candidate IO pairs, and the IO placer adds the second IO pair to the first network design to form a third network design when the second network design is not preferred to the first network design.

5. An apparatus as defined in claim 1, wherein the network planner comprises:
an intermediate office (IO) pair locator to determine a list of candidate IO pairs;
an IO placer to selectively add one or more IO pairs from the list of candidate IO pairs to a network design to recursively trace the network design tree.

6. An apparatus as defined in claim 5, wherein the network planner further comprises a second IO placer, wherein the IO placer is to recursively trace a first portion of the network design tree and the second IO placer is to recursively trace a second portion of the network design tree.

7. An apparatus as defined in claim 1, further comprising a timer, the network planner to recursively trace the network design tree until the timer expires.

8. An apparatus as defined in claim 6, further comprising a network design selector to compare a first network design identified by the IO placer and a second network design identified by the second IO placer.

9. An apparatus as defined in claim 6, wherein the IO placer is implemented by a first processor and the second IO placer is implemented by a second processor.

10. An apparatus as defined in claim 1, wherein a depth of the network design tree recursively traced by the network planner depends on a number of candidate IO node pairs.

11. A method of designing a communication network, the method comprising:
adding a first intermediate office (IO) node pair to a first network design to form a second network design;
adding a second IO node pair to the second network design to form a third network design when the second network design represents a potentially better solution than a previously preferred solution; and
adding a third IO node pair to the first network design to form a fourth network design when the second network design represents a worse solution than the previously preferred solution.

12. A method as defined in claim 11, wherein the communication network is a fiber-optic network for delivering digital video, digital voice, and high-speed data services.

13. A method as defined in claim 11, further comprising recursively tracing a network design tree to automatically add the second IO node pair to the second network design to form the third network design when the second network design represents a potentially better solution than the previously preferred solution.

14. A method as defined in claim 11, wherein the second network design represents a better solution than the previously preferred solution when the second network serves more service switches.

15. A method as defined in claim 11, wherein the second network design represents a better solution than the previously preferred solution when the second network serves more central offices.

16. A method as defined in claim 11, wherein the second network design represents a better solution than the previously preferred solution when the second network costs less.

17. A method as defined in claim 11, further comprising configuring the communication network to implement at least one of the previously preferred solution, the first network design, the second network design, the third network design or the fourth network design.

18. A method as defined in claim 11, further comprising:
adding a fourth IO node pair to the third network design when the third network design represents a potentially better solution than the second network design.

19. A method as defined in claim 18, further comprising adding a fifth node pair to the third network design when the third network design represents a worse solution than the second network design.

20. A method as defined in claim 11, wherein the second network design comprises:
the first IO node pair:
a first fiber connecting a video head-end (VHO) to a first one of the first IO node pair;
a second fiber connecting the VHO to a second one of the first IO node pair; and
a third fiber between the first one of the first IO node pair and a subtending central office; and
a fourth fiber between the second one of the first IO node pair and the subtending central office.

21. A method as defined in claim 20, wherein the first network design further comprises a fifth fiber between the first one and the second one of the first IO node pair.

22. A method as defined in claim 20, wherein the first, the second, the third and the fourth fibers are physically diverse.

23. A method as defined in claim 11, wherein a first one of the first IO node pair implements a multi-service edge router, wherein the multi-service edge router transports digital video signals between a video hub office (VHO) and a subtending central office (CO).

24. A method as defined in claim 11, further comprising:
calculating a list of candidate IO node pairs based on the first network design; and
selecting the first IO node pair from the list of candidate IO node pairs.

25. An article of manufacture storing machine readable instructions which, when executed, cause a machine to:
present a first interface that allows a user to provide a topology for a fiber-optic network;
present a second interface that allows the user to provide traffic forecast data; and
present a third interface that allows the user to initiate a recursive tracing of network design tree to select a design for the fiber-optic network.

26. An article of manufacture as defined in claim 25, wherein the machine readable instructions, when executed, cause the machine to:
choose an Intermediate Office (IO) node pair:
select a first fiber to connect a video head-end (VHO) to a first one of the IO node pair;
select a second fiber to connect the VHO to a second one of the IO node pair; and
select a third fiber between the first one of the IO node pair and a subtending central office (CO); and
select a fourth fiber between the second one of the IO node pair and the subtending CO.

27. An article of manufacture as defined in claim 26, wherein the machine readable instructions, when executed, cause the machine to select a fifth fiber between the first and the second ones of the IO node pair.

28. An article of manufacture as defined in claim 26, wherein the machine readable instructions, when executed, cause the machine to select the first, the second, the third and the fourth fibers to be physically diverse.

29. An article of manufacture as defined in claim 26, wherein the first one of the IO node pair implements a multi-service edge router, and wherein the multi-service edge router transports digital video signals between the VHO and the subtending CO.

30. An article of manufacture as defined in claim 26, wherein the machine readable instructions, when executed, cause the machine to select the IO node pair to reduce a number of unserved central offices.

31-42. (canceled)
